(19) United States
(12) Patent Application Publication
(10) Pub. No.: US 2024/0160920 A1
(43) Pub. Date: May 16, 2024

(54) METHOD OF LEARNING NEURAL NETWORK, RECORDING MEDIUM, AND REMAINING LIFE PREDICTION SYSTEM

(71) Applicant: NEC Corporation, Tokyo (JP)

(72) Inventor: Masanao NATSUMEDA, Tokyo (JP)

(73) Assignee: NEC Corporation, Tokyo (JP)

(21) Appl. No.: 18/383,254

(22) Filed: Oct. 24, 2023

(30) Foreign Application Priority Data
Nov. 11, 2022 (JP) 2022-181009

(51) Int. Cl. G06N 3/08

(52) U.S. Cl. CPC G06N 3/08

(57) ABSTRACT

A method of learning a neural network includes:
obtaining unlabeled data including maintenance cycle data that are time series operation data of a target device that is a maintenance target, and labeled data including lifecycle data that are time series operation data up to failure occurrence of the target device; and
updating a weight parameter of the neural network so as to reduce a prediction error of a difference in the remaining life between two points in the maintenance cycle data and a prediction error of the remaining life in the lifecycle data.

### INCORPORATION BY REFERENCE

This application is based upon and claims the benefit of priority from Japanese Patent Application No. 2022-181009, filed on Nov. 11, 2022, the disclosure of which is incorporated herein in its entirety by reference.

### TECHNICAL FIELD

Example embodiments of this disclosure relate to technical field of a method of learning a neural network, a recording medium, and a remaining life prediction system.

### BACKGROUND ART

In order to perform maintenance of various devices, a method of estimating a remaining life of a device (i.e., a period until a failure or malfunction occurs) is known. For example, Patent Literature 1 discloses that the remaining life of a NAND flash memory provided in a numerical control apparatus of a machine tool is predicted by a machine learning model.

### Prior Art Documents

### Patent Literature

### [Patent Literature 1] Japanese Patent No. 6386523

### SUMMARY

In the above Patent Literature 1, in order to learn a model of estimating the remaining life, it is premised that data can be sufficiently obtained until the failure occurs. It is, however, not easy to collect the data up to the failure occurrence, because maintenance is performed before the failure occurrence in an actual maintenance method. If data used for learning are insufficient, estimation accuracy of the remaining life by the learned model becomes low. It is also conceivable to use data with pseudo-labels, but in this case, a cost of estimating the pseudo-labels is high. This disclosure aims to improve the technical problems described above.

A learning of learning a neural network according to an example aspect of this disclosure is a method of learning a neural network that predicts a remaining life of a target device that is a maintenance target, the method including: obtaining unlabeled data including maintenance cycle data that are time series operation data of the target device, and labeled data including lifecycle data that are time series operation data up to failure occurrence of the target device; and updating a weight parameter of the neural network so as to reduce a prediction error of a difference in the remaining life between two points in the maintenance cycle data and a prediction error of the remaining life in the lifecycle data.

A recording medium according to an example aspect of this disclosure is a non-transitory recording medium on which a computer program that allows a computer to execute a method of learning a neural network that predicts a remaining life of a target device that is a maintenance target is recorded, the method including: obtaining unlabeled data including maintenance cycle data that are time series operation data of the target device, and labeled data including lifecycle data that are time series operation data up to failure occurrence of the target device; and updating a weight parameter of the neural network so as to reduce a prediction error of a difference in the remaining life between two points in the maintenance cycle data and a prediction error of the remaining life in the lifecycle data.

A remaining life prediction system according to an example aspect of this disclosure is a remaining life prediction system including a neural network that predicts a remaining life of a target device that is a maintenance target, wherein the neural network is learned by obtaining unlabeled data including maintenance cycle data that are time series operation data of the target device, and labeled data including lifecycle data that are time series operation data up to failure occurrence of the target device; and updating a weight parameter of the neural network so as to reduce a prediction error of a difference in the remaining life between two points in the maintenance cycle data and a prediction error of the remaining life in the lifecycle data.

### BRIEF DESCRIPTION OF THE DRAWINGS

FIG. 1 is a block diagram illustrating a hardware configuration of a remaining life prediction system according to to first example embodiment;

FIG. 2 is a block diagram illustrating a functional configuration of the remaining life prediction system according to the first example embodiment;

FIG. 3 is a flowchart illustrating a flow of a learning operation of the remaining life prediction system according to the first example embodiment;

FIG. 4 is a flowchart illustrating a flow of a prediction operation of the remaining life prediction system according to the first example embodiment;

FIG. 5 is a conceptual diagram illustrating an example of a time change in a soundness degree of a device in maintenance cycle data and lifecycle data;

FIG. 6 is a conceptual diagram illustrating a learning method in the case of using labeled data in the remaining life prediction system according to the first example embodiment;

FIG. 7 is a conceptual diagram illustrating a learning method in the case of using unlabeled data in the remaining life prediction system according to the first example embodiment;

FIG. 8 is version 1 of a graph illustrating an example of a method of selecting another point in a remaining life prediction system according to a second example embodiment;

FIG. 9 is version 2 of a graph illustrating an example of the method of selecting the other point in the remaining life prediction system according to the second example embodiment;

FIG. 10 is a flowchart illustrating a flow of a learning process performed by a remaining life prediction system according to a third example embodiment;

FIG. 11 is a conceptual diagram illustrating a method of prior learning in a remaining life prediction system according to a fourth example embodiment; and

FIG. 12 is a table illustrating a difference in the method of selecting the other point at each learning stage in the remaining life prediction system according to the fourth example embodiment.

### EXAMPLE EMBODIMENTS

Hereinafter, a method of learning a neural network, a recording medium, and a remaining life prediction system according to example embodiments will be described with reference to the drawings. The following describes an example in which the method of learning the neural network is performed in the remaining life prediction system.

### First Example Embodiment

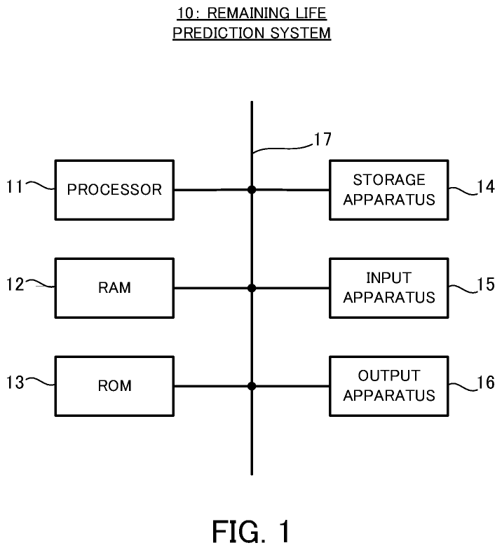

A remaining life prediction system according to a first example embodiment will be described with reference to FIG. 1 to FIG. 7.

### Hardware Configuration

First, with reference to FIG. 1, a hardware configuration of the remaining life prediction system according to the first example embodiment will be described. FIG. 1 is a block diagram illustrating the hardware configuration of the remaining life prediction system according to the first example embodiment.

As illustrated in FIG. 1, a remaining life prediction system 10 according to the first example embodiment includes a processor 11, a RAM (Random Access Memory) 12, a ROM (Read Only Memory) 13, and a storage apparatus 14. The remaining life prediction system 10 may further include an input apparatus 15 and an output apparatus 16. The processor 11, the RAM 12, the ROM 13, the storage apparatus 14, the input apparatus 15, and the output apparatus 16 are connected through a data bus 17.

The processor 11 reads a computer program. For example, the processor 11 is configured to read a computer program stored by at least one of the RAM 12, the ROM 13 and the storage apparatus 14. Alternatively, the processor 11 may read a computer program stored in a computer-readable recording medium, by using a not-illustrated recording medium reading apparatus. The processor 11 may obtain (i.e., read) a computer program from a not-illustrated apparatus disposed outside the remaining life prediction system 10, through a network interface. The processor 11 controls the RAM 12, the storage apparatus 14, the input apparatus 15, and the output apparatus 16 by executing the read computer program. Especially in this example embodiment, when the processor 11 executes the read computer program, a functional block for predicting a remaining life of a target device and a functional block for learning a neural network are realized or implemented in the processor 11. That is, the processor 11 may function as a controller for executing each control in the remaining life prediction system 10 according to this example embodiment.

The processor 11 may be configured as, for example, a CPU (Central Processing Unit), a GPU (Graphics Processing Unit), a FPGA (field-programmable gate array), a DSP (Demand-Side Platform), ASIC (Application Specific Integrated Circuit), or quantum processor. The processor 11 may include one of them, or may use a plurality of them in parallel.

The RAM 12 temporarily stores the computer program to be executed by the processor 11. The RAM 12 temporarily stores the data that is temporarily used by the processor 11 when the processor 11 executes the computer program. The RAM 12 may be, for example, a D-RAM (Dynamic Random Access Memory) or a SRAM (Static Random Access Memory). Another type of volatile memory may also be used in place of the RAM 12.

The ROM 13 stores the computer program to be executed by the processor 11. The ROM 13 may otherwise store fixed data. The ROM 13 may be, for example, a P-ROM (Programmable Read Only Memory) or an EPROM (Erasable Read Only Memory). Another type of non-volatile memory may also be used in place of the ROM 13.

The storage apparatus 14 stores the data that is stored for a long term by the remaining life prediction system 10. The storage apparatus 14 may operate as a temporary storage apparatus of the processor 11. The storage apparatus 14 may include, for example, at least one of a hard disk apparatus, a magneto-optical disk apparatus, a SSD (Solid State Drive), and a disk array apparatus.

The input apparatus 15 is an apparatus that receives an input instruction from a user of the remaining life prediction system 10. The input apparatus 15 may include, for example, at least one of a keyboard, a mouse, and a touch panel. The input apparatus 15 may be configured as a portable terminal, such as a smartphone and a tablet. The input apparatus 15 may be an apparatus that allows an audio input including a microphone, for example.

The output apparatus 16 is an apparatus that outputs information about the remaining life prediction system 10 to the outside. For example, the output apparatus 16 may be a display apparatus (e.g., a display) that is configured to display the information about the remaining life prediction system 10. Furthermore, the output apparatus 16 may be a speaker or the like that audio-outputs the information about the remaining life prediction system 10. The output apparatus 16 may be configured as a portable terminal, such as a smartphone or a tablet. Furthermore, the output apparatus 16 may be an apparatus that outputs the information in a format other than an image.

FIG. 1 exemplifies the remaining life predicting system 10 including a plurality of apparatuses, but all or a part of the functions may be realized by a single apparatus. In that instance, the remaining life prediction system 10 may be include only the processor 11, the RAM 12, and the ROM 13, and the other components (i.e., the storage apparatus 14, the input apparatus 15, and the output apparatus 16) may be provided for an external apparatus connected to the remaining life prediction system 10. Furthermore, the remaining life prediction system 10 may be configured such that a partial arithmetic function is realized or implemented by an external apparatus (e.g., an external server or a cloud, etc.).

### Functional Configuration

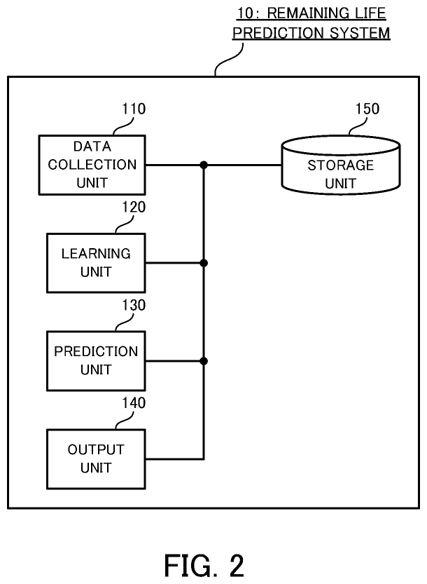

Next, with reference to FIG. 2, a functional configuration of the remaining life prediction system 10 according to the first example embodiment will be described. FIG. 2 is a block diagram illustrating the functional configuration of the remaining life prediction system according to the first example embodiment.

As illustrated in FIG. 2, the remaining life prediction system 10 according to the first example embodiment includes, as components for realizing the functions thereof, a data collection unit 110, a learning unit 120, a prediction unit 130, an output unit 140, and a storage unit 150. Each of the data collection unit 110, the learning unit 120, the prediction unit 130, and the output unit 140 may be a processing block that is realized or implemented by the processor 11 (see FIG. 1), for example. Furthermore, the storage unit 150 may be realized or implemented by the storage apparatus 14 (see FIG. 1), for example.

The data collection unit 110 is configured to collect maintenance cycle data of the target device that is a maintenance target. The maintenance cycle data are time series operation data from immediately after the maintenance of the target device to immediately before next maintenance. The maintenance cycle data are in a condition in which a failure or malfunction of the target device has not yet occurred, and are thus unlabeled data that do not include information about a time of failure occurrence. In the following, the maintenance cycle data, or a data group including a plurality of maintenance data, are referred to as “unlabeled data” as appropriate.

The data collection unit 110 is further configured to collect lifecycle data of the target device that is a maintenance target. The lifecycle data are time series operation data up to failure occurrence of the target device. For this reason, the lifecycle data are labeled data including the information about the failure time. Hereinafter, the lifecycle data, or a data group including a plurality of lifecycle data, are referred to as “labeled data” as appropriate.

The target device is not particularly limited as long as it is a device for performing the maintenance, but an example thereof includes a hard disk, a NAND flash memory, and a rotating device (e.g., a pump, a fan, etc.). In the case of the hard disk, the maintenance cycle data may include S.M.A.R.T information, and Write Count, Average Write Response Time, Max Write Response Time, Write Transfer Rate, Read Count, Average Read Response Time, Max Read Time, Read Transfer Rate, Busy Ratio, Busy Time, or the like that are available from a RAID controller or the like, for example. In the case of the NAND flash memory, the maintenance cycle data and the lifecycle data may include a number of times of rewriting, a rewrite interval, a number of times of reading, temperature in an use environment, an error rate, information about a manufacturing maker, and information about a manufacturing lot, as well as information about an error correction coding (ECC) performance, information about a manufacturing maker, and information about a manufacturing lot of a memory controller that performs an ECC process on the NAND flash memory, or the like. In the case of the rotating device, the maintenance cycle data and the lifecycle data may include an output value of a strain gage, a torque of a motor, current an ultrasonic wave (AE sensor), an accelerometer, or the like.

The learning unit 120 is configured to learn a model for predicting the remaining life (i.e., a period until a failure occurs) of the target device, by using the maintenance cycle data and the lifecycle data collected by the data collection unit 110, as learning data. Specifically, the learning unit 120 updates a weight parameter of the neural network so as to reduce a prediction error of a difference in the remaining life between two points in the maintenance cycle data and a prediction error of the remaining life in the lifecycle data.

The prediction unit 130 is configured to predict the remaining life of the target device, by using the model learned by the learning unit 120. Specifically, the prediction unit 130 is configured to input the maintenance cycle data collected by the data collection unit 110 to the model that is already learned as data for predicting the remaining life, thereby to predict the remaining life of the target device corresponding to the maintenance cycle data. The prediction operation by the prediction unit 130 will be described in detail later.

The output unit 140 is configured to output various types of information in the remaining life prediction system 10. For example, the output unit 140 may be configured to output information about the remaining life of the target device predicted by the prediction unit 130. In this case, the information to be outputted may indicate a value of the remaining life, or may be an alarm corresponding to the remaining life (e.g., information for prompting the maintenance) or the like. The output unit 140 may be configured to output various types of information through the output apparatus 16. For example, the output unit 140 may be configured to output various types of information through a monitor, a speaker, or the like.

The storage unit 150 is configured to be store various types of information handled by the remaining life prediction system 10. The storage unit 150 may be configured to store the model learned by the learning unit 120, for example. The storage unit 150 may be configured to store the maintenance cycle data and the lifecycle data collected by the data collection unit 110.

### Learning Operation

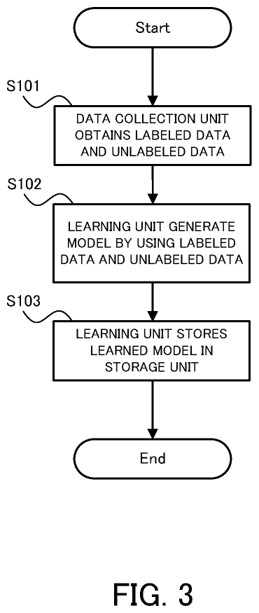

Next, a learning operation (i.e., an operation when the model for predicting the remaining life is learned) by the remaining life prediction system 10 according to the first example embodiment will be described with reference to FIG. 3. FIG. 3 is a flowchart illustrating a flow of the learning operation of the remaining life prediction system according to the first example embodiment.

As illustrated in FIG. 3, when the learning operation of the remaining life prediction system 10 according to the first example embodiment is started, first, the data collection unit 110 obtains the labeled data (i.e., the lifecycle data) and the unlabeled data (i.e., the maintenance cycle data) (step S101). At this time, the data collection unit 110 may newly collect each of the data from the target device, or may obtain each of the data collected in the past from the storage unit 150. The labeled data and the unlabeled data obtained by the data collection unit 110 are both outputted to the learning unit 120.

Subsequently, the learning unit 120 learns the model for predicting the remaining life of the target device, by using the labeled data and the unlabeled data as the learning data (step S102). The learning operation of learning the model by the learning unit 120 will be described in detail later. When the learning is ended, the learning unit 120 stores the learned model in the storage unit 150 (step S103).

### Prediction Operation

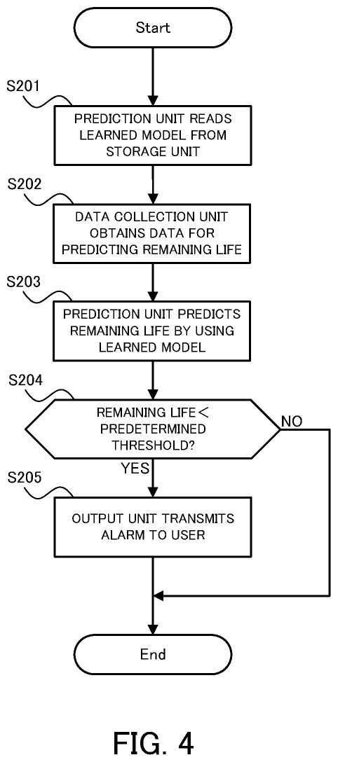

Next, with reference to FIG. 4, a prediction operation (i.e., an operation when the remaining life is predicted by using the learned model) by the remaining life prediction system 10 according to the first example embodiment will be described. FIG. 4 is a flowchart illustrating a flow of the prediction operation of the remaining life prediction system according to the first example embodiment.

As illustrated in FIG. 4, when the prediction operation of the remaining life prediction system 10 according to the first example embodiment is started, first, the prediction unit 130 reads the learned model from the storage unit 150 (step S201).

Subsequently, the data collection unit 110 obtains the maintenance cycle data for predicting the remaining life (step S202). At this time, the data collection unit 110 may newly collect the maintenance cycle data from the target device, or may obtain the maintenance cycle data collected in the past from the storage unit 150. The maintenance cycle data obtained by the data collection unit 110 are outputted to the prediction unit 130.

Then, the prediction unit 130 predicts the remaining life of the target device by using the learned model (step S203). Then, the prediction unit 130 determines whether or not the predicted remaining life is less than a predetermined threshold (step S204). The “predetermined threshold” here is a threshold for determining whether or not to perform the maintenance of the target device, and an arbitrary value may be set in advance.

When the predicted remaining life is less than the predetermined threshold (step S204: YES), the output unit 140 outputs an alarm to the user (step S205). The alarm may include information that promotes a maintenance work, for example. On the other hand, when the predicted remaining life is not less than the predetermined threshold (step S204: NO), the step S205 may be omitted. Even when the predicted remaining life is not less than the predetermined threshold, however, the output unit 140 may output information indicating about when to perform a next maintenance work, on the basis of the predicted remaining life.

### Learning Method

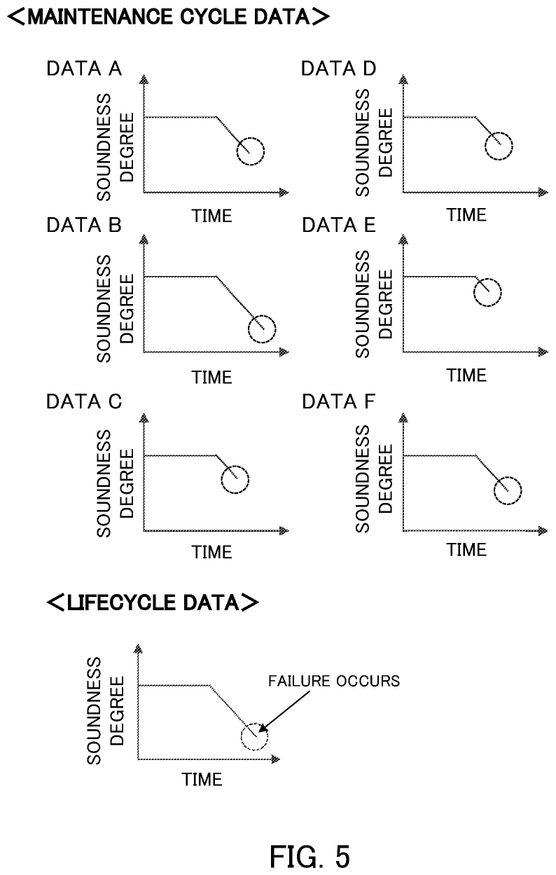

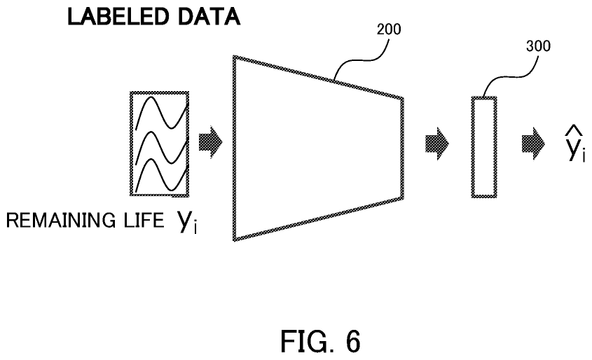

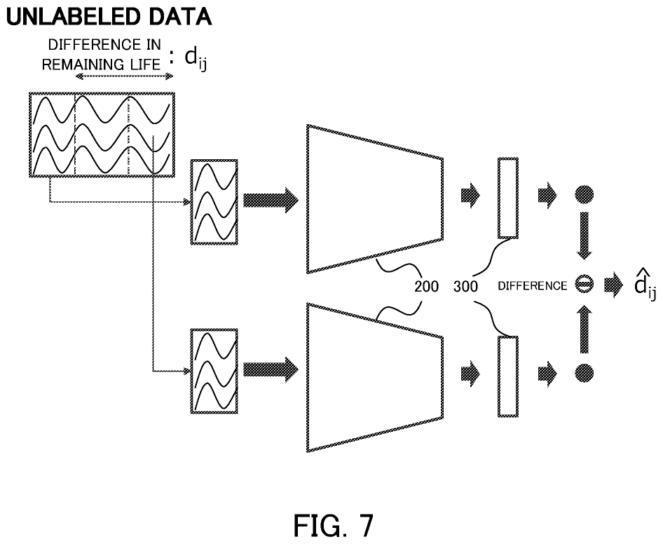

Next, the learning method in the remaining life prediction system 10 according to the first example embodiment will be described in detail with reference to FIG. 5 to FIG. 7. FIG. 5 is a conceptual diagram illustrating an example of a time change in a soundness degree of a device in the maintenance cycle data and the lifecycle data. FIG. 6 is a conceptual diagram illustrating the learning method in the case of using the labeled data in the remaining life prediction system according to the first example embodiment. FIG. 7 is a conceptual diagram illustrating the learning method in the case of using the unlabeled data in the remaining life prediction system according to the first example embodiment.

In FIG. 5, the remaining life prediction system 10 according to the first example embodiment uses a plurality of maintenance cycle data (e.g., see data A to F in the figure) as unlabeled learning data. The plurality of maintenance cycle data may be obtained from each separate device, or may be obtained from the same device at different times. The maintenance cycle data may be a value obtained from the target device or a sensor installed in the vicinity thereof for each maintenance cycle, or a statistical value thereof (in every certain period, but it is not an entire maintenance cycle), and may be typically multi-dimensional time series data. A soundness degree in the figure is a hypothetical index, and may be a value that cannot be actually observed. The soundness degree here matches the remaining life in a deteriorated area (i.e., an area with a deteriorated soundness degree).

The remaining life prediction system 10 according to the first example embodiment further uses the lifecycle data as labeled learning data. As in the maintenance cycle data, the lifecycle data may be a value obtained from the target device or a sensor installed in the vicinity thereof, or a statistical value thereof (in every certain period, but it is not an entire maintenance cycle), and may be typically multi-dimensional time series data. Unlike the maintenance cycle data, however, the lifecycle data include information about timing when a failure occurs in the target device. The amount of the lifecycle data used for the learning may be relatively smaller than that of the maintenance cycle data.

As illustrated in FIG. 6 and FIG. 7, the remaining life prediction system 10 according to the first example embodiment performs the learning by inputting the labeled data and the unlabeled data to the model for predicting the remaining life of the target device. The model for predicting the remaining life includes a feature extractor 200 that extracts a feature quantity from the inputted data, and a prediction layer 300 that predicts the remaining life from the feature quantity. The feature extractor 200 may include, for example, a neural network that is configured to convert series data into vectors, such as a regression neural network (RNN, LSTM, GRU, etc.), CNN, and Transformer, and a neural network that converts vectors such as Multilayer Perceptron, into other vectors. The prediction layer 30 may include a neural network that converts vectors such as Multilayer Perceptron, into other vectors.

In FIG. 6, when the labeled data are inputted as the learning data, the model for predicting the remaining life outputs a remaining life y\hat{ }ᵢ predicted from the labeled data. In the case of the labelled data, since the original data include a remaining life yᵢ that is a correct answer, a prediction error between the remaining life y, that is a correct answer and the predicted remaining life yA, can be used for the learning. Specifically, as will be described later, it is sufficient to perform the learning using a loss function including the prediction error between the remaining life yᵢ that is a correct answer and the predicted remaining life y\hat{ }ᵢ.

In FIG. 7, when the unlabeled data are inputted as the learning data, the model for predicting the remaining life performs the learning by inputting two pieces of partial data included in the unlabeled data. Specifically, the model performs the learning by using a prediction difference between a difference d\hat{ }ᵢⱼ obtained by inputting the two pieces of partial data and a difference dᵢⱼ in the remaining life between the two pieces of partial data. That is, under the assumption that the difference dᵢⱼ in the remaining life between the two pieces of partial data matches the difference d\hat{ }ᵢⱼ in the predicted remaining life, the model performs the learning so as to reduce the prediction error between dᵢⱼ and the d\hat{ }ᵢⱼ.

The loss function in the learning using the labeled data and the unlabeled data may be calculated as a weighted sum of the prediction error when the labeled data are inputted and the prediction error when the unlabeled data are inputted, for example. Specifically, a loss L may be calculated as the following equation (1), for example.

$$\begin{matrix}[ Equation 1 ] & \\ L = {\sum }_{i ∈ {B}_{l}} {( {y}_{i} - \hat{{y}_{i}} )}^{2} + λ {\sum }_{( i , j ) ∈ {B}_{ul}} {( {d}_{ij} - )}^{2} & ( 1 )\end{matrix}$$

Bₗ here is an index of sampled labeled data and Bᵤₗ is an index pair of sampled unlabeled data. λ is a regularization parameter.

In the learning, it is sufficient to update a weight parameter of the model so as to reduce (preferably, minimize) the loss L. A more specific flow of a learning process will be described in detail in another example embodiment later.

### Technical Effect

Next, a technical effect obtained by the remaining life prediction system 10 according to the first example embodiment will be described.

As described in FIG. 1 to FIG. 7, in the remaining life prediction system 10 according to the first example embodiment, the learning is performed so as to reduce the prediction error of the difference in the remaining life between two points in the unlabeled data and the prediction error of the remaining life in the labeled data. In this way, even when the amount of the labeled data is not sufficient, it is possible to properly perform the learning by using the unlabeled data. As a result, it is possible to realize the remaining life prediction system that is configured to predict the remaining life of the target device with high accuracy, while reducing a cost of collecting the learning data.

### Second Example Embodiment

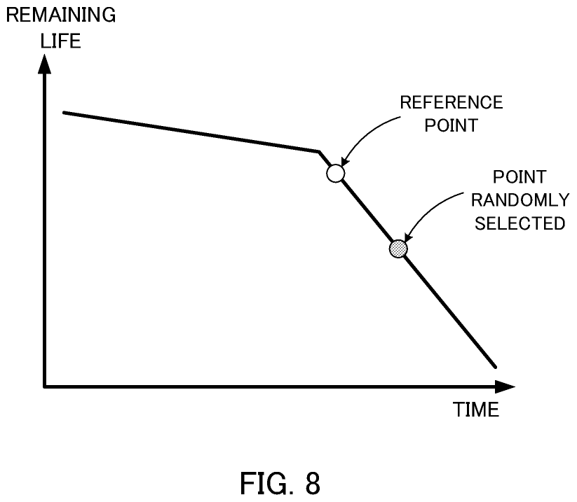

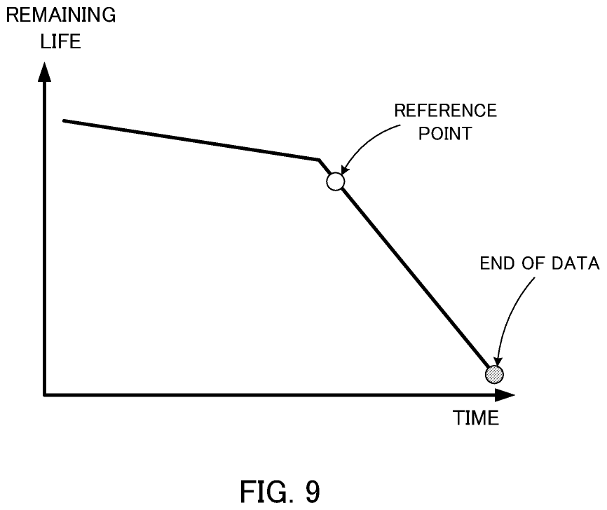

The remaining life prediction system 10 according to a second example embodiment will be described with reference to FIG. 8 and FIG. 9. The second example embodiment is intended to describe a more specific operation example of the first example embodiment, and may be the same as the first example embodiment in the system configuration, the flow of the overall operation or the like. For this reason, a part that is different from the first example embodiment will be described in detail below, and a description of other overlapping parts will be omitted as appropriate.

### Selection of Two Points

First, with reference to FIG. 8 and FIG. 9, handling of the unlabeled data in the remaining life prediction system 10 according to the second example embodiment will be described. FIG. 8 is version 1 of a graph illustrating an example of a method of selecting another point in the remaining life prediction system according to the second example embodiment. FIG. 9 is version 2 of a graph illustrating an example of the method of selecting the other point in the remaining life prediction system according to the second example embodiment/

[symbol]

As described in the first example embodiment, in the learning using the unlabeled data, the difference in the remaining life between two points in the maintenance cycle data is used. The two points are selected as a reference point and another point for each maintenance cycle data. The reference point may be selected in advance, or may be selected at each time. The reference point may be randomly selected from the maintenance cycle data. On the other hand, the other point is selected as another point corresponding to the reference point. The other point may be one selected on a different basis as described below.

As illustrated in FIG. 8, the other point may be randomly selected from the same maintenance cycle data as those of the reference point. In this case, since the position of the other point is not limited, it is possible to capture various features in the maintenance cycle data. The other point may be completely randomly selected, or may be randomly selected from a predetermined range. For example, the other point may be randomly selected from a part in which the remaining life is smaller than that of the reference point in the maintenance cycle data. Alternatively, the other point may be randomly selected from a range set near an end (a last time of the data) of the maintenance cycle data.

As illustrated in FIG. 9, the other point may be selected as a point corresponding to the end of the same maintenance cycle data as those of the reference point. In this case, since the point at which the remaining life in the maintenance cycle data is the shortest is selected, it is possible to perform the learning that increases accuracy of predicting the remaining life.

### Technical Effect

Next, a technical effect obtained by the remaining life prediction system 10 according to the second example embodiment will be described.

As described in FIG. 8 and FIG. 9, in the remaining life prediction system 10 according to the second example embodiment, the reference point and the other point are both selected, and the learning is performed using the difference in the remaining life between the two points. In this way, it is possible to properly perform the learning by using the unlabeled data that do not include the information about the time of failure occurrence.

### Third Example Embodiment

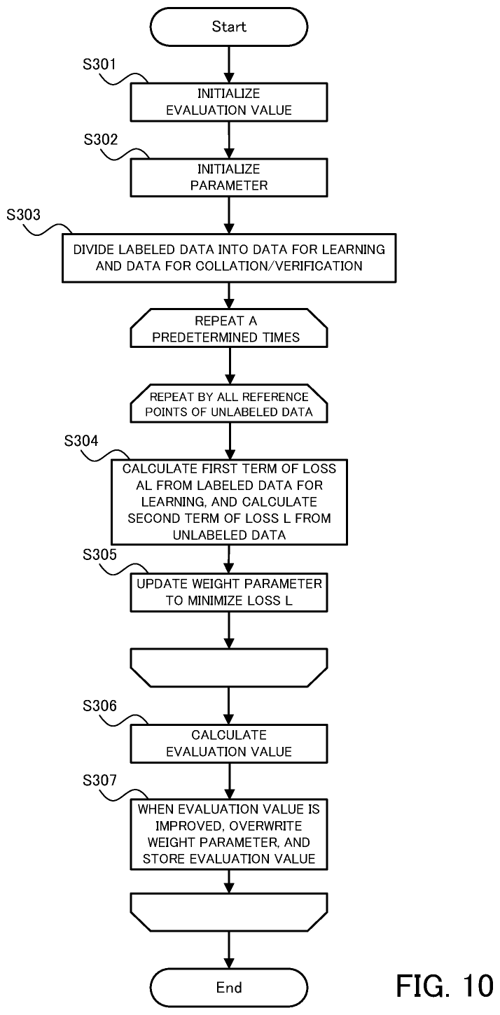

The remaining life prediction system 10 according to a third example embodiment will be described with reference to FIG. 10. The third example embodiment is intended to describe a specific example of the learning process in the first example embodiment, and may be the same as the first and second example embodiments in the other parts. For this reason, a part that is different from each of the example embodiments described above will be described in detail below, and a description of other overlapping parts will be omitted as appropriate.

### Flow of Learning Process

First, with reference to FIG. 10, a flow of the learned process (specifically, the step S102 described in FIG. 3) performed by the remaining life predicting system 10 according to the third example embodiment will be described in detail. FIG. 10 is a flowchart illustrating the flow of the learning process performed by the remaining life prediction system according to the third example embodiment.

As illustrated in FIG. 10, when the learning process by the remaining life prediction system 10 according to the third example embodiment is started, first, the learning unit 130 initializes an immediately preceding evaluation value (described in detail later) (step S301). Furthermore, the learning unit 130 initializes the weight parameter of the model to be learned (step S302). An initial value of the weight parameter may be a value randomly set in a predetermined manner. Alternatively, the initial value of the weight parameter may be a value set by prior learning (see another example embodiment described later).

Subsequently, the learning unit 130 divides the labeled data into data for learning and data for collation/verification (step S303). The labeled data may be randomly divided into the data for learning and the data for collation/verification. In the following, the labeled data divided for learning will be sometimes referred to as “labeled data for learning” and the labeled data divided for collation/verification will be sometimes referred to as “labeled data for collation/verification”.

Subsequently, the learning unit 130 calculates a first term of the loss L from the labeled data for learning, and calculates a second term of the loss L from the unlabeled data (step S304). That is, the learning unit 130 calculates the loss L by using the above-described equation (1). Then, the learning unit 130 updates the weight parameter of the model so as to minimize the calculated loss L (step S305).

In particular, the steps S304 and S305 are repeated until all the reference points in the unlabeled data are used to calculate the loss L. When the amount of the labeled data for learning is less than that of the unlabeled data, the labeled data may be used in duplicate, but it is preferable to use the same data in duplicate as little as possible.

The reference point may be determined more from a part in which the remaining life in the maintenance cycle data is short. That is, a relatively small number of reference points are determined from a part in which the remaining life is relatively long (i.e., a part in which an elapsed time is not so long), and a relatively large number of reference points may be determined may be determined from the part in which the remaining life is relatively short (i.e., a part in which an elapsed time is long). For example, more reference points may be determined as the remaining life becomes shorter. In this way, data in which the target device is close to breakdown or failure is more considered, and it is thus possible to perform the learning that increases the accuracy of predicting the remaining life.

After all the reference points are used, the learning unit 130 calculates an evaluation value for collating/verifying the updated weight parameter (in other words, a collation/verification value) (step S306). The “evaluation value” here is an index for determining whether to store the updated weight parameter as the best value, and may be a function including the loss L or the first term of the loss L, or may be the loss L itself, for example.

Subsequently, when the evaluation value is improved, the learning unit 130 overwrites and stores the weight parameter of the model in the storage unit 150 (step S307). That is, the weight parameter that is updated so far is once determined. The steps S304 to S307 are repeated by a preset number of iterations. In this way, in the learning process, the weight parameter is repeatedly updated and overwritten.

### Technical Effect

Next, a technical effect obtained by the remaining life prediction system 10 according to the third example embodiment will be described.

As described in FIG. 10, in the remaining life prediction system 10 according to the third example embodiment, the evaluation value is calculated at each time when the weight parameter is updated by using all the reference points set in each of the maintenance cycle data, and the weight parameter is overwritten and stored in the evaluation value on the basis of the collation/verification value. In this way, the number of epochs in the learning process is based on the amount of the unlabeled data, and thus, even if the amount of the labeled data (i.e., the lifecycle data) is less than that of the unlabeled data (i.e., the maintenance cycle data), it is possible to properly perform the learning process without overmatching a small amount of labeled data.

### Fourth Example Embodiment

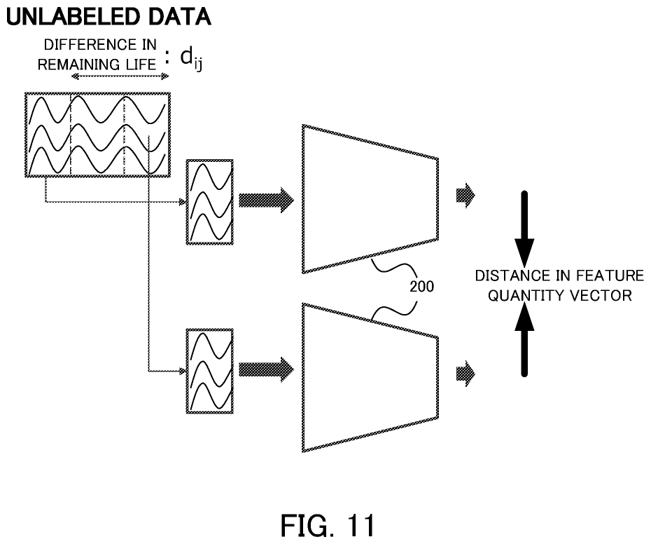

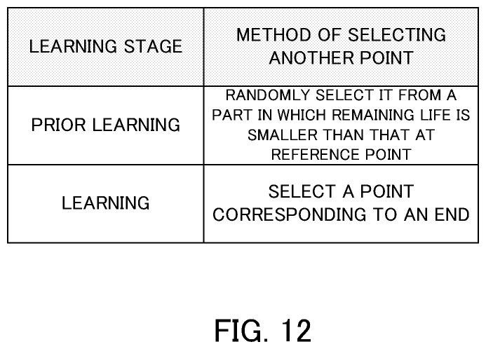

The remaining life prediction system 10 according to a fourth example embodiment will be described with reference to FIG. 11 and FIG. 12. The fourth example embodiment is partially different from the first to third example embodiments only in the operation, and may be the same as the first to third example embodiments in the other parts. For this reason, a part that is different from each of the example embodiments described above will be described in detail below, and a description of other overlapping parts will be omitted as appropriate.

### Prior Learning

First, with reference to FIG. 11, prior learning performed by the remaining life prediction system 10 according to the fourth example embodiment will be described. FIG. 11 is a conceptual diagram illustrating a method of the prior learning in the remaining life prediction system according to the fourth example embodiment.

In the remaining life prediction system 10 according to the fourth example embodiment, the prior learning is performed before the learning described in the first to third example embodiments (hereinafter, referred to as “main learning”). That is, first, the prior learning is performed, and the main learning is performed by taking over a result of the prior learning.

In FIG. 11, the prior learning is performed as a process of updating a weight parameter of the feature extractor 200 included in the model for predicting the remaining life. Specifically, the weight parameter of the feature extractor 200 is updated such that the difference dᵢⱼ in the remaining life between two points in the operation data that belong to the same maintenance cycle is a distance in a feature quantity vector between two points outputted from the feature extractor 200. The prior learning may be performed by the same method as in the main learning described above. For this reason, a description of a specific learning technique in the prior learning is omitted.

### Difference at Learning Stage

Next, with reference to FIG. 12, a difference in the method of selecting the other point between the prior learning and the main learning will be described. FIG. 12 is a table illustrating the difference in the method of selecting the other point at each learning stage in the remaining life prediction system according to the fourth example embodiment.

As illustrated in FIG. 12, the remaining life prediction system 10 according to the fourth example embodiment may change the method of selecting the other point (i.e., the other point corresponding to the reference point) in accordance with a learning stage. Specifically, in the prior learning, the other point is randomly selected from the part in which the remaining life is shorter than that at the reference point. In this way, it is possible to perform the prior learning in consideration of the maintenance cycle data. On the other hand, in the main learning, the point corresponding to the end of the maintenance cycle data is selected as the other point. In this way, data in which the target device is close to breakdown or failure is more considered, and it is thus possible to perform the learning that increases the accuracy of predicting the remaining life.

### Technical Effect

Next, a technical effect obtained by the remaining life prediction system 10 according to the fourth example embodiment will be described.

As described in FIG. 11, in the remaining life prediction system 10 according to the fourth example embodiment, first, the prior leaning is performed on the feature extractor 200, and then, the main learning of the entire model for predicting the remaining life is performed. In this way, the weight parameter of the feature extractor 200 may be brought close to an appropriate value by the prior learning, and it is thus possible to perform more appropriate learning as a whole, as compared with the case where the main learning is performed from the beginning (i.e., the case where the prior learning is not performed).

A processing method in which a program for allowing the configuration in each of the example embodiments to operate to realize the functions of each example embodiment is recorded on a recording medium, and the program recorded on the recording medium is read as a code and executed on a computer, is also included in the scope of each of the example embodiments. That is, a computer-readable recording medium is also included in the range of each of the example embodiments. Not only the recording medium on which the above-described program is recorded, but also the program itself is also included in each example embodiment.

The recording medium to use may be, for example, a floppy disk (registered trademark), a hard disk, an optical disk, a magneto-optical disk, a CD-ROM, a magnetic tape, a nonvolatile memory card, or a ROM. Furthermore, not only the program that is recorded on the recording medium and executes processing alone, but also the program that operates on an OS and executes processing in cooperation with the functions of expansion boards and another software, is also included in the scope of each of the example embodiments. In addition, the program itself may be stored in a server, and a part or all of the program may be downloaded from the server to a user terminal. The program may be provided to the user in the form of SaaS (Software as a Service), for example.

### Supplementary Notes

The example embodiments described above may be further described as, but not limited to, the following Supplementary Notes.

### Supplementary Note 1

A method of learning a neural network according to Supplementary Note 1 is a method of learning a neural network that predicts a remaining life of a target device that is a maintenance target, the method including: obtaining unlabeled data including maintenance cycle data that are time series operation data of the target device, and labeled data including lifecycle data that are time series operation data up to failure occurrence of the target device; and updating a weight parameter of the neural network so as to reduce a prediction error of a difference in the remaining life between two points in the maintenance cycle data and a prediction error of the remaining life in the lifecycle data.

### Supplementary Note 2

The method of learning the neural network according to Supplementary Note 2 is the method of learning the neural network according to Supplementary Note 1, wherein the difference in the remaining life in the maintenance cycle data is a difference between a predicted value of the remaining life at a reference point of the maintenance cycle data and a predicted value of the remaining life at a point randomly selected from the same maintenance cycle data as those of the reference point.

### Supplementary Note 3

The method of learning the neural network according to Supplementary Note 3 is the method of learning the neural network according to Supplementary Note 1, wherein the difference in the remaining life in the maintenance cycle data is a difference between a predicted value of the remaining life at a reference point of the maintenance cycle data and a predicted value of the remaining life at a point corresponding to an end of the same maintenance cycle data as those of the reference point.

### Supplementary Note 4

The method of learning the neural network according to Supplementary Note 4 is the method of learning the neural network according to any one of Supplementary Notes 1 to 3, further including: determining a reference point in advance for each of the maintenance cycle data; calculating a collation/verification value for collating/verifying the weight parameter at each time when the weight parameter is updated by using all the reference points; and overwriting the weight parameter on the basis of the collation/verification value.

### Supplementary Note 5

The method of learning the neural network according to Supplementary Note 5 is the method of learning the neural network according to Supplementary Note 4, wherein the reference point is determined more from a part in which the remaining life in the maintenance cycle data is short.

### Supplementary Note 6

The method of learning the neural network according to Supplementary Note 6 is the method of learning the neural network according to any one of Supplementary Notes 1 to 5, wherein the neural network includes: a feature extractor that converts operation data into a feature quantity vector; and a predicted layer that converts the feature quantity vector into a predicted value of the remaining life, and the method further includes: performing prior learning of a weight parameter of the feature extractor is performed such that a difference in the remaining life between two points in operation data that belong to the same maintenance cycle data is a distance in the feature quantity vector between the two points outputted from the feature extractor; and updating the weight parameter of the neural network so as to reduce the prediction error of the difference in the remaining life between the two points in the maintenance cycle data and the prediction error of the remaining life in the lifecycle data, as main learning that uses the weight parameter of the feature extractor learned by the prior learning as an initial value.

### Supplementary Note 7

The method of learning the neural network according to Supplementary Note 7 is the method of learning the neural network according to Supplementary Note 6, wherein the difference in the remaining life in the prior learning is a difference between a predicted value of the remaining life at a reference point of the maintenance cycle data and a predicted value of the remaining life at a point randomly selected from a part of the same maintenance cycle data as the reference point that has a shorter remaining life than the reference point, and the difference in the remaining life in the main learning is a difference between the predicted value of the remaining life at the reference point of the maintenance cycle data and a predicted value of the remaining life at a point corresponding to an end of the same maintenance cycle data as those of the reference point.

### Supplementary Note 8

A computer program according to Supplementary Note 8 is a computer program that allows a computer to execute a method of learning a neural network that predicts a remaining life of a target device that is a maintenance target, the method including: obtaining unlabeled data including maintenance cycle data that are time series operation data of the target device, and labeled data including lifecycle data that are time series operation data up to failure occurrence of the target device; and updating a weight parameter of the neural network so as to reduce a prediction error of a difference in the remaining life between two points in the maintenance cycle data and a prediction error of the remaining life in the lifecycle data.

### Supplementary Note 9

A recording medium according to Supplementary Note 9 is a non-transitory recording medium on which a computer program that allows a computer to execute a method of learning a neural network that predicts a remaining life of a target device that is a maintenance target is recorded, the method including: obtaining unlabeled data including maintenance cycle data that are time series operation data of the target device, and labeled data including lifecycle data that are time series operation data up to failure occurrence of the target device; and updating a weight parameter of the neural network so as to reduce a prediction error of a difference in the remaining life between two points in the maintenance cycle data and a prediction error of the remaining life in the lifecycle data.

### Supplementary Note 10

A remaining life prediction system according to Supplementary Note 10 is a remaining life prediction system including a neural network that predicts a remaining life of a target device that is a maintenance target, wherein the neural network is learned by obtaining unlabeled data including maintenance cycle data that are time series operation data of the target device, and labeled data including lifecycle data that are time series operation data up to failure occurrence of the target device; and updating a weight parameter of the neural network so as to reduce a prediction error of a difference in the remaining life between two points in the maintenance cycle data and a prediction error of the remaining life in the lifecycle data.

### Supplementary Note 11

A remaining life prediction apparatus according to Supplementary Note 11 is a remaining life prediction apparatus including a neural network that predicts a remaining life of a target device that is a maintenance target, wherein the neural network is learned by obtaining unlabeled data including maintenance cycle data that are time series operation data of the target device, and labeled data including lifecycle data that are time series operation data up to failure occurrence of the target device; and updating a weight parameter of the neural network so as to reduce a prediction error of a difference in the remaining life between two points in the maintenance cycle data and a prediction error of the remaining life in the lifecycle data.

This disclosure is not limited to the above-described examples and is allowed to be changed, if desired, without departing from the essence or spirit of the invention which can be read from the claims and the entire specification. A method of learning a neural network, a recording medium, and a remaining life prediction system with such changes, are also included in the technical concepts of this disclosure.

### DESCRIPTION OF REFERENCE NUMERALS

10 Remaining life prediction system
11 Processor
14 Storage apparatus
110 Data collection unit
120 Learning unit
130 Prediction unit
140 Output unit
150 Storage unit
200 Feature extractor
300 Prediction layer

What is claimed is:

1. A method of learning a neural network that predicts a remaining life of a target device that is a maintenance target, the method comprising:
obtaining unlabeled data including maintenance cycle data that are time series operation data of the target device, and labeled data including lifecycle data that are time series operation data up to failure occurrence of the target device; and
updating a weight parameter of the neural network so as to reduce a prediction error of a difference in the remaining life between two points in the maintenance cycle data and a prediction error of the remaining life in the lifecycle data.

2. The method of learning the neural network according to claim 1, wherein the difference in the remaining life in the maintenance cycle data is a difference between a predicted value of the remaining life at a reference point of the maintenance cycle data and a predicted value of the remaining life at a point randomly selected from the same maintenance cycle data as those of the reference point.

3. The method of learning the neural network according to claim 1, wherein the difference in the remaining life in the maintenance cycle data is a difference between a predicted value of the remaining life at a reference point of the maintenance cycle data and a predicted value of the remaining life at a point corresponding to an end of the same maintenance cycle data as those of the reference point.

4. The method of learning the neural network according to claim 1, further comprising:
determining a reference point in advance for each of the maintenance cycle data;
calculating a collation/verification value for collating/verifying the weight parameter at each time when the weight parameter is updated by using all the reference points; and
overwriting the weight parameter on the basis of the collation/verification value.

5. The method of learning the neural network according to claim 4, wherein the reference point is determined more from a part in which the remaining life in the maintenance cycle data is short.

6. The method of learning the neural network according to claim 1, wherein
the neural network includes: a feature extractor that converts operation data into a feature quantity vector; and a predicted layer that converts the feature quantity vector into a predicted value of the remaining life, and
the method further comprises:
performing prior learning of a weight parameter of the feature extractor is performed such that a difference in the remaining life between two points in operation data that belong to the same maintenance cycle data is a distance in the feature quantity vector between the two points outputted from the feature extractor; and
updating the weight parameter of the neural network so as to reduce the prediction error of the difference in the remaining life between the two points in the maintenance cycle data and the prediction error of the remaining life in the lifecycle data, as main learning that uses the weight parameter of the feature extractor learned by the prior learning as an initial value.

7. The method of learning the neural network according to claim 6, wherein
the difference in the remaining life in the prior learning is a difference between a predicted value of the remaining life at a reference point of the maintenance cycle data and a predicted value of the remaining life at a point randomly selected from a part of the same maintenance cycle data as the reference point that has a shorter remaining life than the reference point, and
the difference in the remaining life in the main learning is a difference between the predicted value of the remaining life at the reference point of the maintenance cycle data and a predicted value of the remaining life at a point corresponding to an end of the same maintenance cycle data as those of the reference point.

8. A non-transitory recording medium on which a computer program that allows a computer to execute a method of learning a neural network that predicts a remaining life of a target device that is a maintenance target is recorded, the method including:
obtaining unlabeled data including maintenance cycle data that are time series operation data of the target device, and labeled data including lifecycle data that are time series operation data up to failure occurrence of the target device; and
updating a weight parameter of the neural network so as to reduce a prediction error of a difference in the remaining life between two points in the maintenance cycle data and a prediction error of the remaining life in the lifecycle data.

9. A remaining life prediction system comprising a neural network that predicts a remaining life of a target device that is a maintenance target, wherein the neural network is learned by
obtaining unlabeled data including maintenance cycle data that are time series operation data of the target device, and labeled data including lifecycle data that are time series operation data up to failure occurrence of the target device; and
updating a weight parameter of the neural network so as to reduce a prediction error of a difference in the remaining life between two points in the maintenance cycle data and a prediction error of the remaining life in the lifecycle data.
